(19) United States
(12) Patent Application Publication
(10) Pub. No.: US 2011/0164129 A1
(43) Pub. Date: Jul. 7, 2011

(54) METHOD AND A SYSTEM FOR CREATING A REFERENCE IMAGE USING UNKNOWN QUALITY PATTERNS

(75) Inventors: Yuri Postolov, Afula (IL); Menachem Regensburger, Shimshit (IL); Roni Flieswasser, Grimberger (BE)

(73) Assignee: Camtek Ltd., Migdal-Haemek (IL)

(21) Appl. No.: 12/064,365

(22) PCT Filed: Aug. 30, 2006
(86) PCT No.: PCT/IL06/01006

§ 371 Date: Dec. 31, 2008

(30) Foreign Application Priority Data
Sep. 1, 2005 (IL) 170609

(51) Int. Cl. H04N 7/18; G06K 9/00

(52) U.S. Cl. 348/87; 382/149; 348/E07.085

(57) ABSTRACT

A method and a system for preparing a pattern's reference-model to be used for automatic inspection of surface are disclosed. The system according to the present invention is comprised of an imaging device that captured images of plurality of the patters; a dedicated software that uses dedicated algorithms to correct and align the captured images; and a controller operative for collecting the same located and same coincident pixel of each of the images; choosing, according to predetermined criteria, one of the collected pixels; creating a new image with same dimensions as the captured images and locating the chosen pixel in the same place corresponding to the place of the collected pixels in the origin images; repeating the process as defined above for each pixel of the captured images; and providing the new created image as a reference model for inspecting the pattern.

### FIELD OF THE INVENTION

The present invention relates to the field of automatic optical inspection systems and methods. More specifically, the present invention relates to a method and system for creating reference image of a pattern.

### BACKGROUND OF THE INVENTION

Automatic optical inspection systems use image processing and dedicated algorithms to inspect patterns that are located on a surface. The present invention relates to this area and particularly for inspection of circles on a PCB or dice on a wafer in order to recognize, analyze and classify defects.

Commonly, a reference image of a die is used to inspect the on-wafer dice by comparison each die with a reference image of the die. This reference image is acquired from the wafer, which unfortunately has production residues. Indeed, correction methods and techniques are used to achieve better reference image but some of residues are still remained and interfere the inspection process.

The present invention provides a method and a system that enables to achieve a clean reference image from unknown quality dice's images, which were acquired from a real unknown quality wafer.

### SUMMARY OF THE INVENTION

The present invention is a method and a system for creating a reference image-model for inspecting patterns on a surface, useful particularly for inspection of dice on a wafer or repeatable circles on PCB.

According to the teachings of the present invention there is provided a method for preparing a pattern's reference-model to be used for automatic inspection of surface that includes a plurality such pattern, this method comprising:
acquiring images of a plurality of the pattern;
aligning all of the images, in a common coordinate system;
correcting the images; and
creating a reference-model image, wherein each pixel in the created reference-model image is made by choosing the best pixel of the same located and same coincident pixel of these images.

According to another aspect of the present invention the method is also provided wherein the pattern is a die, the surface is a wafer and the reference-model is made for inspecting dice on a wafer.

According to another aspect of the present invention the method is also provided wherein the images' correction includes geometrical-correction that optionally includes shift, rotation, scale, shrink, local distortion or any other geometrical-correction and radio-metrical-correction of the gray level of each pixel by using plurality of well known technique.

According to another aspect of the present invention the method is also provided wherein the choice of each pixel for creating the reference-model image includes the following steps:
collecting the coincident pixels in same location from each of images;
sorting the collected pixels by gray level value; and
choosing a pixel from the largest pixels-cluster in the sort distribution.

According to yet another aspect, the method is also provided wherein a cluster is defined as a group of pixels' values that the distance between each of its member is smaller than a predetermined value.

Moreover, the method is also provided wherein the chosen pixel is the median pixel of the largest pixels-cluster.

According to another aspect, the mentioned method further includes additional calculation to be stored corresponding to each pixel for use with the inspection algorithms, these calculations are:
finding the median of the largest cluster;
finding MIN value of the cluster and applying cross kernel or 3×3 kernel or any other Min-Max kernel to find the MIN of gray level from pixels covered by kernel; and
finding MAX value of the cluster and applying cross kernel or 3×3 kernel or any other Min-Max kernel to find the MAX of gray level from pixels covered by kernel.

According to another sequence of the provided method is further includes the step, before creating reference-model image:
applying one of the Min-Max kernel on all pixels of the images.

According to the mentioned sequence, the provided method is further includes additional calculation to be stored corresponding each pixel for use with the inspection algorithms, these calculations are:
finding the median of the largest cluster;
finding MIN value of the cluster; and
finding MAX value of the cluster.

According to another aspect of the present invention it is provided a system for preparing a pattern's reference-model to be used for automatic inspection of surface that includes such patterns, this system comprising:
imaging device that captured images of plurality of the patters;
dedicated software that uses dedicated algorithms to correct and align the captured images; and
a controller operative for:
   collecting the same located and same coincident pixel of each of the images;
   collecting the same located and same coincident pixel of each of the images;
   choosing, according to predetermined criteria, one of the collected pixels;
   creating a new image with same dimensions as the captured images and locating the chosen pixel in the same place corresponding to the place of the collected pixels in the origin images;
   repeating the process as defined above for each pixel of the captured images; and
   providing the new created image as a reference model for inspecting the pattern.

According to a preferred embodiment of the present invention, the system is provided wherein the controller is further operative for choosing pixels from the collected pixels by the way of sorting the collected pixels by gray level value and choosing a pixel of the largest pixels-cluster of the sorting distribution.

According to another preferred embodiment of the present invention, the system is provided wherein the chosen pixel is the median pixel of the largest pixels-cluster.

According to another preferred embodiment of the present invention, the system is provided wherein the cluster is defined as a group of pixels' values that the distance between each of its member is smaller than a predetermined value.

According to yet another preferred embodiment of the present invention, the system is provided wherein the controller is further operative for additional calculations to be stored corresponding each pixel for use with the inspection algorithms, these calculations are:
finding and storing the median of the largest cluster;
finding and storing MIN value of the cluster; and
finding and storing MAX value of the cluster.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates a flow chart of the method according to the present invention.

FIG. 2 illustrates the pixel's choosing method.

FIGS. 3 and 4 illustrate the cross-kernel and 3×3 kernel, and example of Min-Max operation.

FIG. 5 illustrates the difference between a reference image that was acquired from the wafer and a reference image of the same die that “designed” by using the method of the present invention.

### DESCRIPTION OF THE PREFERRED EMBODIMENTS

The present invention is a method and a system for creating a reference image-model for inspecting patterns on a surface, useful particularly for inspection of dice on a wafer.

Usually, reference image is an improved image of a die that was improved by using correcting techniques and algorithms. The present invention provides, actually, a method and a system to design a reference image. The designation is done by choosing the best pixel from the appropriate pixels of several image of same pattern.

Moreover, the method and the system are calculating and storing values that can be used by the inspection algorithms.

The principles and operation of the method and the system according to the present invention may be better understood with reference to the drawing and the accompanying description.

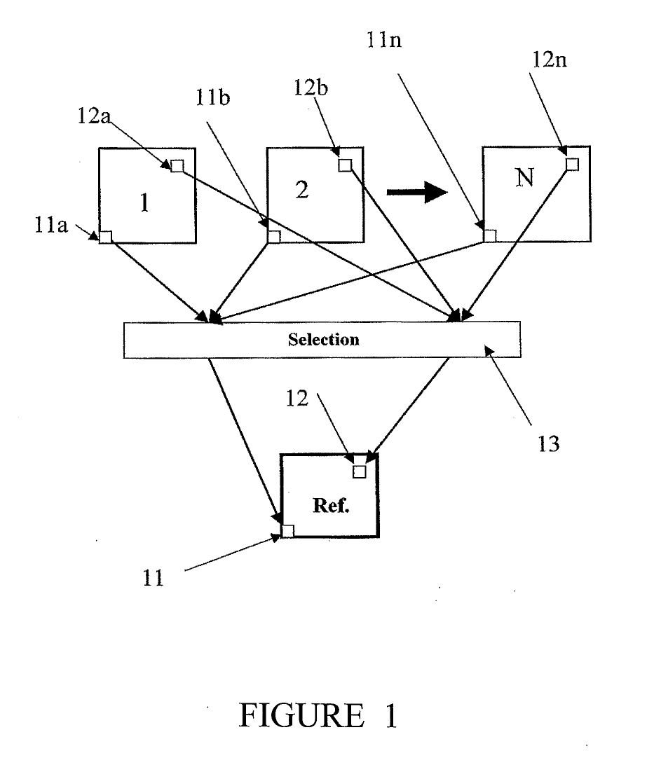

Referring now to the drawing, FIG. 1 illustrates a flow chart of the method according to the present invention. Images of N patterns are acquired 1, 2 . . . N. Starting from the first pixel of each image and collecting the coincident pixels—first pixel 11a from the first image 1, second pixel 11b from the second image 2 and so on until the last pixel 11n from the last image N. All these pixels are from the same location—e.g., from the bottom left corned of the image (or X1Y1 coordination). According to a predetermined criteria, selecting 13 the best pixel of these collected pixels, for example sorting the pixels by gray level value and choosing a pixel from the most significant cluster of the distribution e.g., the median pixel.

The selected pixel 11 is used to design a new reference image Ref. The selected pixel 11 is embedded in the new image in the same location as the location of the collected pixels (e.g., from the bottom left corned of the image). The same process is done for each pixel and a new image Ref. Is built e.g., the coincident pixels 12a from first image 1, 12b from second image 2 and so on until 12n from last image—are collected and one of them is selected 13 and located in the coincident place 12 in the new image Ref.—when the process in finished, a clean reference image-model Ref. Is provided.

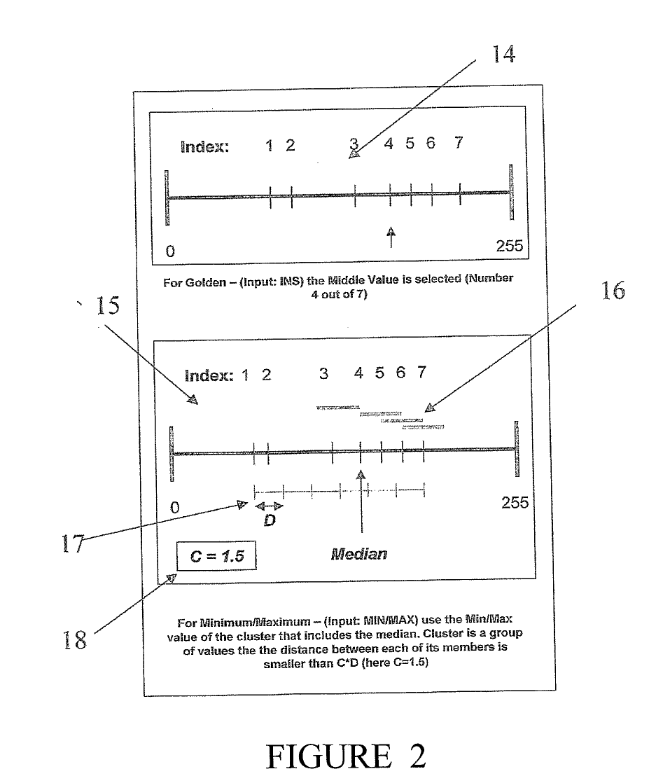

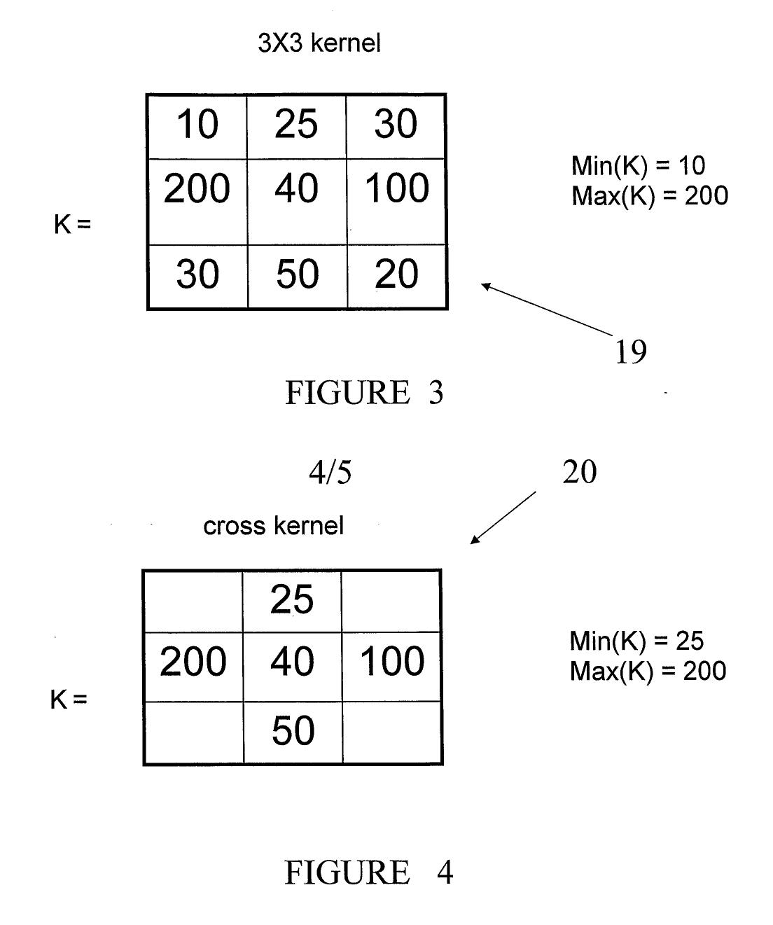

FIG. 2 illustrates the pixel's choosing method. Ordering 14 pixels (1 to 7) according to ascending gray level values (1 is the smallest 7 is the biggest). Clustering 15 of pixels according to gray level distance between the pixels [D=GPixel (i)−GPixel(i−1)] where indicates sample index. A sub cluster 16 value based on the distance criteria D*C (where C is some selected factor). Both D and C are depited as D 17 in based on gray level distance between pixels [D=GPixel (i)−GPixel(i−1)] where i indicates sample index and C 18 is a distance weight coefficient C (e.g. =1.5) FIGS. 3 and 4 illustrate the results of applying cross-kernel and 3×3 kernel. The neighbor pixels information is useful in the inspection process. By applying cross-kernel—FIG. 3—obtaining information regarding four neighbors 19 and by applying 3×3 kernel—FIG. 4—obtaining information regarding nine neighbors 20.

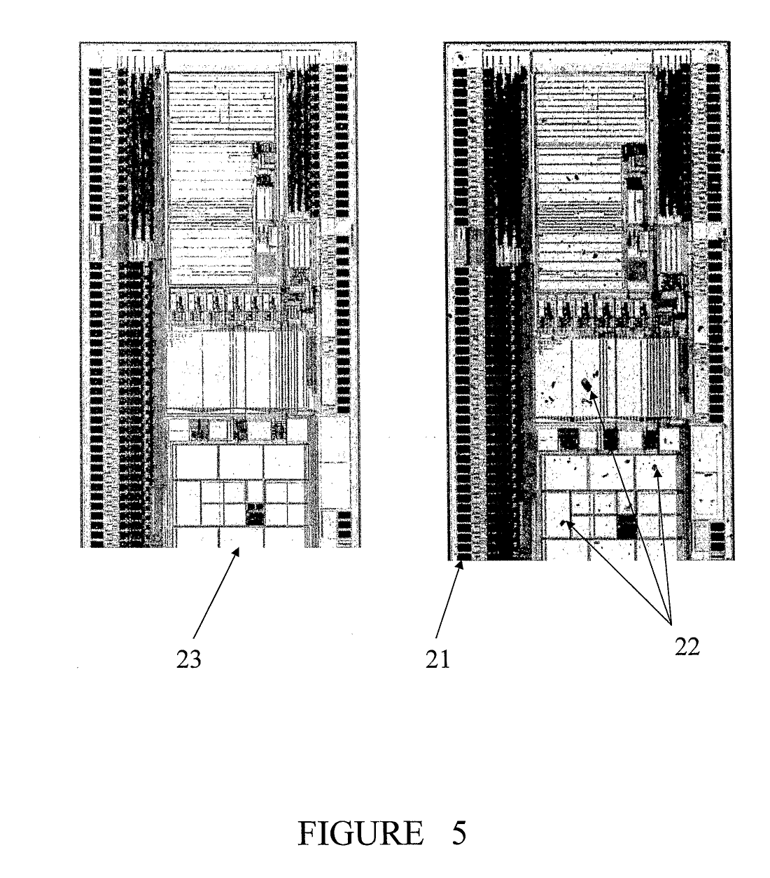

FIG. 5 illustrates the difference between a reference image that was acquired from the wafer and a reference image of the same die that “designed” by using the method of the present invention. The reference image that was acquired from the wafer 21 suffers from defects and stains 22 and on the other hand the designed reference image 23 is clean and significantly better for automatic inspection.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

What is claimed is:

1. A method for preparing a pattern's reference-model to be used for automatic inspection of surface that includes a plurality such pattern, said method comprising:
acquiring images of a plurality of said unknown quality pattern;
aligning all of said images, in a common coordinate system;
correcting said images; and
creating a reference-model image, wherein each pixel in said created reference-model image is made by choosing the best pixel of the same located and same coincident pixel of said images.

2. The method of claim 1, wherein said pattern is a unknown quality die, said surface is a wafer and said reference-model is made for inspecting dice on a wafer.

3. The method of claim 1, wherein said images' correction includes geometrical-correction that optionally includes shift, rotation, scale, shrink, local distortion or any other geometrical-correction and radio-metrical-correction of the gray level of each pixel by using plurality of well known technique.

4. The method of claim 1, wherein the choice of each said pixel for creating said reference-model image includes the following steps:
collecting said coincident pixels in same location from each of said images;
sorting said collected pixels by gray level value; and
choosing a pixel from the largest pixels-cluster in said sort distribution.

5. The method of claim 4, wherein said cluster is defined as a group of pixels' values that the distance between each of its member is smaller than a predetermined value.

6. The method of claim 4, wherein said chosen pixel is the median pixel of said largest pixels-cluster.

7. The method of claim 4, further includes additional calculation to be stored corresponding to each pixel for use with the inspection algorithms, said calculations are:
finding the median of said largest cluster;
finding MIN value of said cluster and applying cross kernel or 3×3 kernel or any other Min-Max kernel to find the MIN of gray level from pixels covered by kernel; and
finding MAX value of said cluster and applying cross kernel or 3×3 kernel or any other Min-Max kernel to find the MAX of gray level from pixels covered by kernel.

8. The method of claim 1, further includes the step, before creating reference-model image:
applying one of the Min-Max kernel on all pixels of said images.

9. The method of claim 8, further includes additional calculation to be stored corresponding each pixel for use with the inspection algorithms, said calculations are:
finding the median of said largest cluster;
finding MIN value of said cluster; and
finding MAX value of said cluster.

10. A system for preparing a pattern's reference-model to be used for automatic inspection of surface that includes such patterns, said system comprising:
imaging device that captured images of plurality of said patters;
dedicated software that uses dedicated algorithms to correct and align said captured images; and
a controller operative for:
collecting the same located and same coincident pixel of each of said images;
choosing, according to predetermined criteria, one of said collected pixels;
creating a new image with same dimensions as said captured images and locating said chosen pixel in the same place corresponding to the place of said collected pixels in the origin images;
repeating the process as defined above for each pixel of said captured images; and
providing said new created image as a reference model for inspecting said pattern.

11. The system of claim 10, wherein said controller is further operative for choosing pixels from said collected pixels by the way of sorting said collected pixels by gray level value and choosing a pixel of the largest pixels-cluster of said sorting distribution.

12. The system of claim 11, wherein said chosen pixel is the median pixel of said largest pixels-cluster.

13. The system of claim 11, wherein said cluster is defined as a group of pixels' values that the distance between each of its member is smaller than a predetermined value.

14. The system of claim 11, wherein said controller is further operative for additional calculations to be stored corresponding each pixel for use with the inspection algorithms, said calculations are:
finding and storing the median of said largest cluster;
finding and storing MIN value of said cluster; and
finding and storing MAX value of said cluster.
